(19) United States
(12) Patent Application Publication
(10) Pub. No.: US 2013/0194597 A1
(43) Pub. Date: Aug. 1, 2013

(54) OPERATION RECEIVING APPARATUS, IMAGE FORMING APPARATUS, AND COMPUTER READABLE MEDIUM

(71) Applicants: Tatsuo FUKUSHIMA, Kanagawa (JP); Hidetomi MURASHITA, Kanagawa (JP)

(72) Inventors: Tatsuo FUKUSHIMA, Kanagawa (JP); Hidetomi MURASHITA, Kanagawa (JP)

(73) Assignee: FUJI XEROX CO., LTD., Tokyo (JP)

(21) Appl. No.: 13/555,665

(22) Filed: Jul. 23, 2012

(30) Foreign Application Priority Data
Jan. 26, 2012 (JP) 2012-013911

(51) Int. Cl. G06K 15/02

(52) U.S. Cl. 358/1.13

(57) ABSTRACT

An operation receiving apparatus includes an input data display unit, an output data display unit, an operation reception unit, and a setting unit. The input data display unit displays input data. The output data display unit displays output data generated from the input data on the basis of a processing condition. The operation reception unit receives an operation for the input data that is displayed by the input data display unit and an operation for the output data that is displayed by the output data display unit. The setting unit sets the processing condition to be different depending on whether the operation reception unit receives an operation as an operation for the input data that is displayed by the input data display unit or as an operation for the output data that is displayed by the output data display unit.

### CROSS-REFERENCE TO RELATED APPLICATIONS

This application is based on and claims priority under 35 USC 119 from Japanese Patent Application No. 2012-013911 filed Jan. 26, 2012.

### BACKGROUND

### Technical Field

The present invention relates to an operation receiving apparatus, an image forming apparatus, and a computer readable medium.

### SUMMARY

According to an aspect of the invention, there is provided an operation receiving apparatus including an input data display unit, an output data display unit, an operation reception unit, and a setting unit. The input data display unit displays input data. The output data display unit displays output data generated from the input data on the basis of a processing condition. The operation reception unit receives an operation for the input data that is displayed by the input data display unit and an operation for the output data that is displayed by the output data display unit. The setting unit sets the processing condition to be different depending on whether the operation reception unit receives an operation as an operation for the input data that is displayed by the input data display unit or as an operation for the output data that is displayed by the output data display unit.

### BRIEF DESCRIPTION OF THE DRAWINGS

Exemplary embodiment of the present invention will be described in detail based on the following figures, wherein:

FIG. 1 is a cross-sectional view illustrating an image forming apparatus which is an exemplary operation receiving apparatus according to an exemplary embodiment of the present invention;

FIG. 2 is a block diagram illustrating a hardware configuration of the image forming apparatus;

FIG. 3 is a block diagram illustrating a program that is executed in the image forming apparatus;

FIGS. 4A and 4B are schematic diagrams illustrating exemplary screens which are used for setting printing conditions and which are displayed on a user interface (UI) apparatus;

FIGS. 5A and 5B are schematic diagrams for explaining a difference in a setting operation using a gesture made by moving a touched position along the shape of a cross, between the state in which the gesture is made as an input-display operation and the state in which the gesture is made as an output-display operation;

FIGS. 6A and 6B are schematic diagrams for explaining a difference in a setting operation using a first setting-operation image, between the state in which the operation is performed as an input-display operation and the state in which the operation is performed as an output-display operation;

FIGS. 7A and 7B are schematic diagrams for explaining a difference in a setting operation using a second setting-operation image, between the state in which the operation is performed as an input-display operation and the state in which the operation is performed as an output-display operation;

FIGS. 8A and 8B are schematic diagrams for explaining a difference in a setting operation using a gesture for changing a margin width, between the state in which the gesture is made as an input-display operation and the state in which the gesture is made as an output-display operation;

FIGS. 9A and 9B are schematic diagrams for explaining a difference in a setting operation using a gesture made by moving a touched position starting from a corner of a document data image or a print data image, between the state in which the gesture is made as an input-display operation and the state in which the gesture is made as an output-display operation;

FIGS. 10A and 10B are schematic diagrams for explaining a difference in a setting operation using a third setting-operation image, between the state in which the operation is performed as an input-display operation and the state in which the operation is performed as an output-display operation;

FIGS. 11A to 11D are schematic diagrams illustrating the relationship between the orientation of a document and a layout setting operation;

FIGS. 12A and 12B are schematic diagrams for explaining a difference in a printing condition which is caused by a difference in a processing sequence in which a setting operation for changing a margin width and a setting operation for adding an additional image are performed;

FIG. 13 is a schematic diagram for illustrating a difference in a printing condition in the case where a layout setting operation, a setting operation for changing a margin width, and a setting operation for adding an additional image are performed in this sequence;

FIG. 14 is a schematic diagram for illustrating a difference in a printing condition in the case where a layout setting operation, a setting operation for adding an additional image, and a setting operation for changing a margin width are performed in this sequence;

FIG. 15 is a flowchart of operations performed by the program; and

FIGS. 16A to 16D are schematic diagrams for explaining printing conditions in the case where a layout setting operation, a setting operation for changing a margin width, a setting operation for adding an additional image, and a setting operation for inserting a piece of inserting paper are performed.

### DETAILED DESCRIPTION

An exemplary embodiment of the present invention will be described in detail below with reference to the drawings.

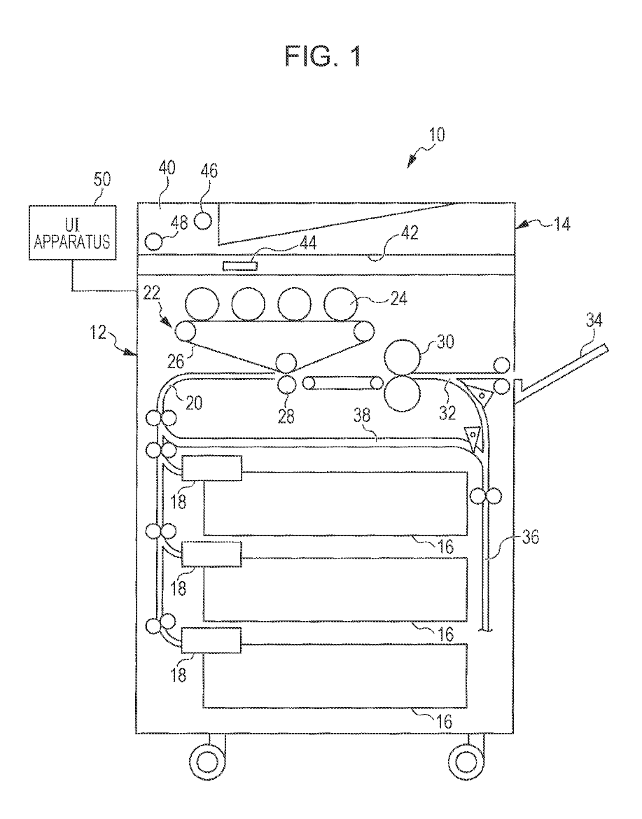

FIG. 1 is a cross-sectional view illustrating an image forming apparatus 10 which is an exemplary operation receiving apparatus according to the exemplary embodiment of the present invention.

The image forming apparatus 10 includes a printer 12 and an image reading apparatus 14. The printer 12 includes, for example, three recording-medium supply cassettes 16, each of which is provided with a supply head 18. Each of the recording-medium supply cassettes 16 may store a recording medium having a size different from those of other cassettes 16. Alternatively, some of the recording-medium supply cassettes 16 may store recording media having the same size, one of which is stored in the landscape orientation in one of the cassettes 16 and another of which is stored in the portrait orientation in another cassette 16.

When one of the recording-medium supply cassettes 16 is selected, a corresponding supply head 18 operates, so that a recording medium is supplied from the selected recording-medium supply cassette 16 through a recording-medium supply path 20 to an image forming unit 22.

The image forming apparatus 10 may also have a facsimile function (not illustrated).

The image forming unit 22 is provided with photoreceptors 24 for yellow, magenta, cyan, and black which are arranged therein, and is also provided with an intermediate transfer belt 26.

For example, a charging device, an exposure device, a developing device, a first transfer device, and a cleaning device (not illustrated) are disposed around each of the photoreceptors 24, and a toner image formed on the photoreceptor 24 is transferred to the intermediate transfer belt 26. In the case where black-and-white printing is set, the operation only for black is allowed to be performed.

A toner image on the intermediate transfer belt 26 is transferred by means of a second transfer roll 28 onto a recording medium which has been fed, and is fixed by a fixing device 30. The recording medium on which the toner image is fixed is ejected through a recording-medium ejection path 32 to an ejection unit 34.

In the case where duplex printing is set, a recording medium having a surface which has been subjected to fixing by the fixing device 30 is fed from the recording-medium ejection path 32 to a reversing device 36, and is reversed by the reversing device 36. The recording medium is fed to a recording-medium reversing path 38 and then back to the recording-medium supply path 20 again, and is fed to the image forming unit 22 so that printing is performed on the backside of the recording medium.

The image reading apparatus 14 includes an automatic document feeder 40 which is capable of reading a double-sided document. The document is fed to a platen 42 by the automatic document feeder 40, and is read on the platen 42 by a reading unit 44 including, for example, charge coupled devices (CCDs). The image reading apparatus 14 may read a document which is placed on the platen 42 by an operator by using the reading unit 44.

A set-document detector 46 is provided which detects whether or not a document is set to the automatic document feeder 40. The automatic document feeder 40 also serves as a platen covering, and a document may be placed on the platen 42 by opening the platen covering. A platen-covering opening/closing detector 48 is capable of detecting the opening/closing of the platen covering.

A user interface apparatus 50 (hereinafter, referred to as a UI apparatus 50) is provided integrally with the image forming apparatus 10 or through a network. The UI apparatus 50, which includes, for example, a touch panel, also receives an instruction, as an input, about a processing condition which is given by an operator to the image forming apparatus 10, or displays information.

The image forming apparatus 10 is provided with a modem for facsimile which is connected to the public circuit, and with a network communication device connected to a network such as a local-area network (LAN). The network communication device provided for the image forming apparatus 10 enables an image read by the image reading apparatus 14 to be transmitted to a terminal connected to the network. The image forming apparatus 10 also receives data from a terminal connected to the network through the network communication device.

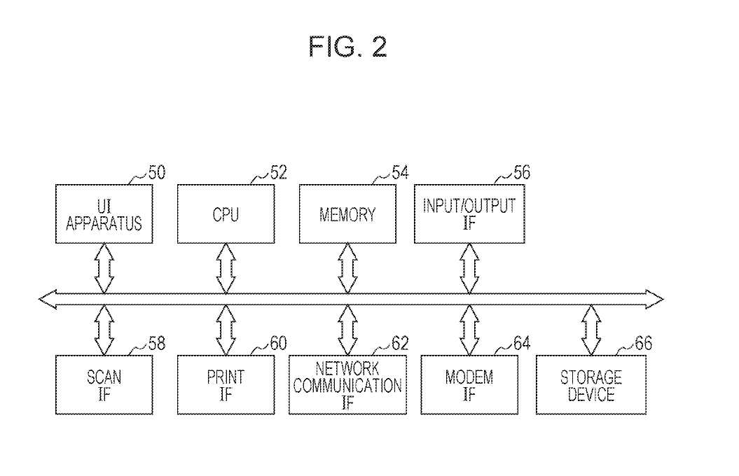

FIG. 2 is a block diagram illustrating a hardware configuration of the image forming apparatus 10.

As illustrated in FIG. 2, the image forming apparatus 10 includes not only the UI apparatus 50 illustrated in FIG. 1, but also a central processing unit (CPU) 52, a memory 54, an input/output interface 56, a scan interface 58, a print interface 60, a network communication interface 62, a modem interface for facsimile 64, and a storage device 66 which are connected to one another via a bus.

That is, the image forming apparatus 10 has components which serve as a computer which is capable of processing information and communicating with other apparatuses.

The CPU 52 executes a program 70 which will be described below and which is stored in the memory 54 or the storage device 66, thereby controlling the operation of the image forming apparatus 10. An input received through the UI apparatus 50 is transmitted to the CPU 52, and display information from the CPU 52 is transmitted to the UI apparatus 50.

The CPU 52 may execute the program 70 stored in a storage medium such as a compact disk read-only memory (CD-ROM). Alternatively, the CPU 52 may execute the program 70 provided through the network communication interface 62.

The input/output interface 56 receives a set-document detection signal from the set-document detector 46 illustrated in FIG. 1 and a platen-covering opening/closing signal from the platen-covering opening/closing detector 48 illustrated in FIG. 1.

The scan interface 58 is connected to the image reading apparatus 14 illustrated in FIG. 1, and the print interface 60 is connected to the printer 12 illustrated in FIG. 1.

The network communication interface 62 is connected to the network communication device provided for the image forming apparatus 10, and the modem interface 64 is connected to the modem for facsimile provided for the image forming apparatus 10.

The storage device 66 is connected to the bus, and it is possible for the storage device 66 provided for the image forming apparatus 10 to store, for example, data transmitted from a terminal connected to the network. The storage device 66 may store an operation sequence described below.

The above-described configuration allows the image forming apparatus 10 to print data that is received through the network communication interface 62 and data that is read by the image reading apparatus 14, by using the printer 12. The image forming apparatus 10 may directly receive data stored in an external storage medium (not illustrated) such as a Universal Serial Bus (USB) memory and print it by using the printer 12.

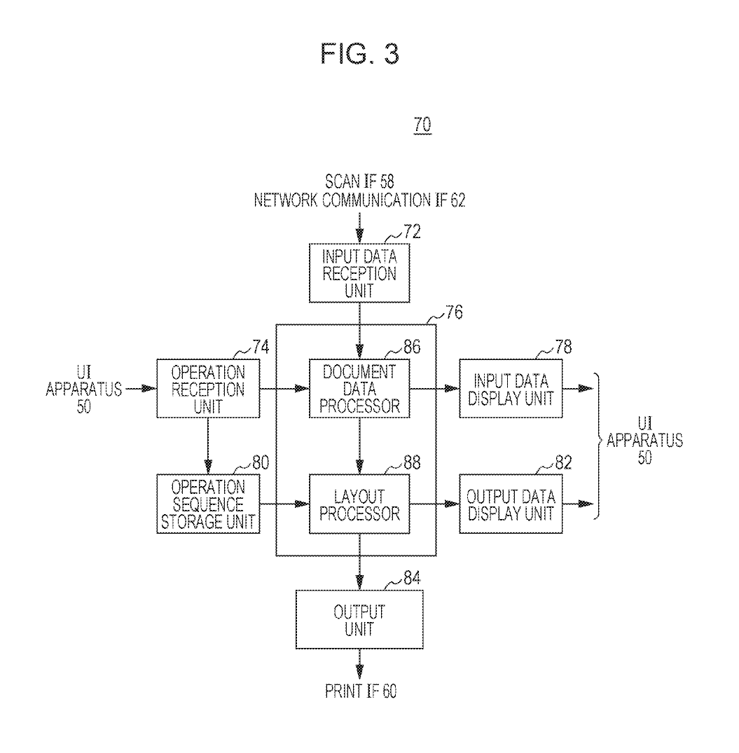

FIG. 3 is a block diagram illustrating the program 70 that is executed in the image forming apparatus 10. As illustrated in FIG. 3, the program 70 includes an input data reception unit 72, an operation reception unit 74, a setting unit 76, an input data display unit 78, an operation sequence storage unit 80, an output data display unit 82, and an output unit 84. The setting unit 76 includes a document data processor 86 which performs a first process and a layout processor 88 which performs a second process.

The input data reception unit 72 receives input data. According to the exemplary embodiment, the input data reception unit 72 receives document data transmitted from a terminal connected to the network or document data read by the image reading apparatus 14, as the input data. The document data means data which is a source of a print target. The input data reception unit 72 may directly receive document data stored in an external storage medium such as a USB memory.

The input data reception unit 72 outputs the received input data to the setting unit 76. The input data may be temporarily stored in a storage unit, such as a storage device or a memory, and be then transmitted through the storage unit to the setting unit 76.

The operation reception unit 74 receives an operation for setting a processing condition that is used when output data is to be generated from input data. Specifically, the operation reception unit 74 receives an operation while determining whether the operation is performed for input data displayed by the input data display unit 78 (hereinafter, sometimes referred to as an “input-display operation”) or for output data displayed by the output data display unit 82 (hereinafter, sometimes referred to as an “output-display operation”). The operation reception unit 74 outputs the received operation to the setting unit 76.

According to the exemplary embodiment, the operation reception unit 74 receives an operation performed by an operator on the UI apparatus 50 while determining whether the operation is an input-display operation or an output-display operation. The operation reception unit 74 outputs the input-display operation to the document data processor 86, and outputs the output-display operation to the operation sequence storage unit 80. Input-display operations include an operation for document data which has been processed by the document data processor 86 and which is displayed by the input data display unit 78, as well as an operation for input data displayed by the input data display unit 78.

The UI apparatus 50 receives designation of a position in the display screen of the UI apparatus 50, and outputs information about the received position, i.e., position information, to the operation reception unit 74. For example, an operator touches any position on the display screen of the UI apparatus 50, or moves a touched position, i.e., makes a gesture, so as to designate a position or positions. The operation reception unit 74 identifies an operation of an operator in accordance with the position information obtained from the UI apparatus 50, and receives the operation.

The setting unit 76 sets a processing condition for generating output data from input data. The setting unit 76 sets different processing conditions depending on whether an operation is received as an input-display operation or as an output-display operation. In accordance with the stored operation sequence, the setting unit 76 also sets processing conditions corresponding to the operations.

According to the exemplary embodiment, even when the setting unit 76 receives the same operations, the setting unit 76 sets different processing conditions depending on whether each of the operations is received as an input-display operation or as an output-display operation. The same operations mean operations which are each obtained through the same procedure performed by an operator, except for the type of each of the operations, i.e., an input-display operation or an output-display operation.

According to the exemplary embodiment, the setting unit 76 sets different printing conditions for document data depending on whether an operation is an input-display operation or an output-display operation. The setting unit 76 according to the exemplary embodiment sets a printing condition by using the document data processor 86 and the layout processor 88.

Now, components of the program 70 which largely relate to an input-display operation will be described.

The document data processor 86 performs a process corresponding to the input-display operation received by the operation reception unit 74 on the document data which is output from the input data reception unit 72, and outputs the resulting data to the input data display unit 78 and the layout processor 88. For example, the document data processor 86 performs a process of changing a margin width or a process of adding an additional image such as a stamp, as a process corresponding to the received input-display operation.

The input data display unit 78 displays input data received by the input data reception unit 72 on the UI apparatus 50. The input data display unit 78 according to the exemplary embodiment displays document data received by the input data reception unit 72 or document data processed by the document data processor 86 on the UI apparatus 50.

At that time, the input data display unit 78 and the output data display unit 82 described below simultaneously perform display on the UI apparatus 50. Specific display examples will be described below.

Now, components of the program 70 which largely relate to an output-display operation will be described.

The operation sequence storage unit 80 stores output-display operations received by the operation reception unit 74 along with the sequence in which the operation reception unit 74 receives the operations.

The layout processor 88 performs the processes corresponding to the operations stored in the operation sequence storage unit 80 in accordance with the stored operation sequence on the document data that has processed by the document data processor 86, and outputs the resulting data to the output data display unit 82 and the output unit 84 as print data. For example, the layout processor 88 performs a process of changing a margin width, a process of adding an additional image such as a stamp, and other processes as processes corresponding to the operations stored in the storage unit 80.

The output data display unit 82 applies the current settings to the input data, and displays the resulting output data on the UI apparatus 50. The output data display unit 82 according to the exemplary embodiment displays the print data generated by applying, to the document data, the printing condition which is currently set for the document data. The print data is displayed by the output data display unit 82 as a preview image, i.e., an image for check, so that an operator checks if the printing condition is correct.

The output unit 84 outputs the processing condition which has been set by the setting unit 76, to a processor which executes a process in accordance with the processing condition. The output unit 84 according to the exemplary embodiment outputs the print data generated by the layout processor 88 to the printer 12. The printer 12 prints the document data in accordance with the printing condition which has been set by the setting unit 76.

Now, a description will be made for a screen which is used for setting printing conditions and which is displayed on the UI apparatus 50.

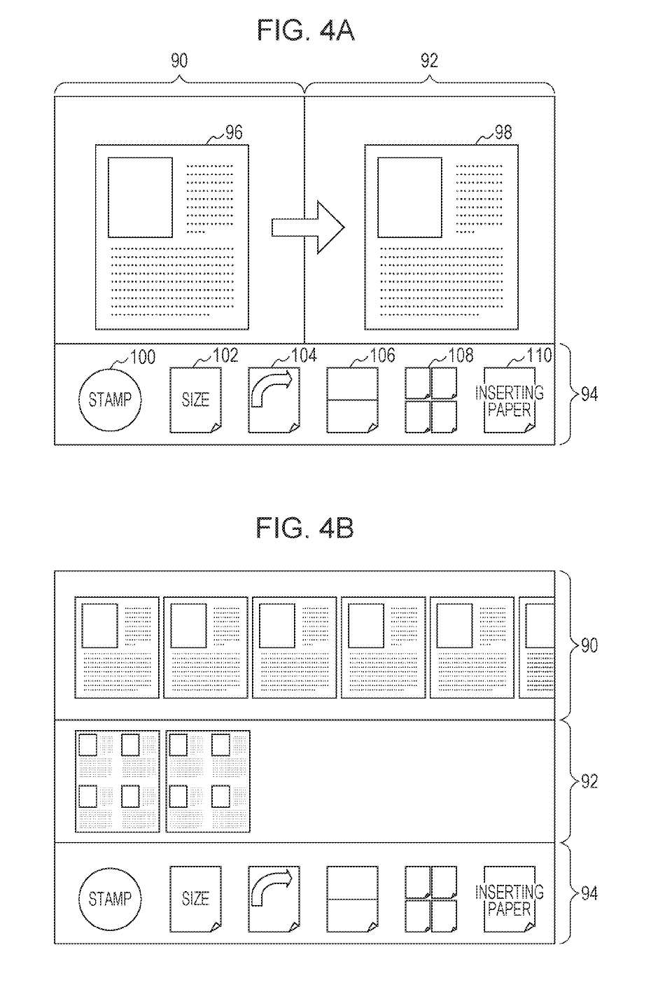

FIGS. 4A and 4B are schematic diagrams illustrating exemplary screens which are used for setting printing conditions and which are displayed on the UI apparatus 50.

As illustrated in FIG. 4A, a screen for setting printing conditions is constituted by, for example, a document data display area 90, a print data display area 92, and a setting-operation image display area 94.

In the document data display area 90, document data 96 is displayed by the input data display unit 78. In the print data display area 92, print data 98 is displayed by the output data display unit 82. In the setting-operation image display area 94, for example, setting-operation images 100 to 110 are displayed as images for setting printing conditions.

In the examples illustrated in FIGS. 4A and 4B, exemplary screens in the states in which no printing conditions are set, i.e., initial states, are illustrated. In the document data display area 90 and the print data display area 92, document data received by the input data reception unit 72 is displayed by the input data display unit 78 and the output data display unit 82, respectively.

Each of the setting-operation images corresponds to one or two setting functions. An operator drags a setting-operation image to the document data display area 90 or the print data display area 92 so as to set a corresponding setting function as a printing condition. In the case where a setting-operation image corresponds to two setting functions, dragging to the document data display area 90, i.e., an input-display operation, causes one of the setting functions to be set, whereas dragging to the print data display area 92, i.e., an output-display operation, causes the other to be set.

According to the exemplary embodiment, the description is made in which a setting function is performed when a setting-operation image is dragged. However, any operation may be employed as long as any one of the setting-operation images 100 to 110 is specified and either of the document data display area 90 and the print data display area 92 is specified.

The setting functions for the setting-operation images 100 to 110 illustrated in FIGS. 4A and 4B will be described below.

The setting-operation image 100 corresponds to a setting function for adding an additional image to document data.

The setting-operation image 102 corresponds to a setting function for changing a printing magnification.

The setting-operation image 104 corresponds to two setting functions: a setting function for changing the orientation of document data (hereinafter, referred to as a document rotation setting operation), and a setting function for changing the orientation of a recording medium used for image formation (hereinafter, referred to as a paper storage orientation setting operation). The document rotation setting operation is performed when the setting-operation image 104 is dragged to the document data display area 90. The paper storage orientation setting operation is performed when the setting-operation image 104 is dragged to the print data display area 92.

For example, assume that one of the multiple recording-medium supply cassettes 16 stores a recording medium in the landscape orientation and another stores a recording medium in the portrait orientation. When the setting-operation image 104 is dragged to the print data display area 92 so that the orientation of the recording medium is set to the landscape orientation, a recording medium in the recording-medium supply cassette 16 which stores the recording medium in the landscape orientation is used for image formation.

In the document rotation setting operation, for example, a setting operation of clockwise rotation by 90° is performed every time the setting-operation image 104 is dragged to the document data display area 90. Accordingly, when the setting-operation image 104 is dragged twice, a setting operation for changing the orientation of the document data 96 by 180° is performed.

The setting-operation image 106 corresponds to a setting function for laying out and printing multiple pages on one recording medium (hereinafter, referred to as a layout setting operation). In the layout setting operation, for example, two pages are laid out when the setting-operation image 106 is dragged once, and four pages are laid out when the setting-operation image 106 is dragged twice.

The setting-operation image 108 corresponds to a setting function for dividing one page into multiple pages to print the resulting pages (hereinafter, referred to as a document division setting operation). In the document division setting operation, for example, a setting operation of division into two pages is performed when the setting-operation image 108 is dragged once, and a setting operation of division into four pages is performed when the setting-operation image 108 is dragged twice.

The setting-operation image 110 corresponds to a setting function for inserting a sheet of inserting paper.

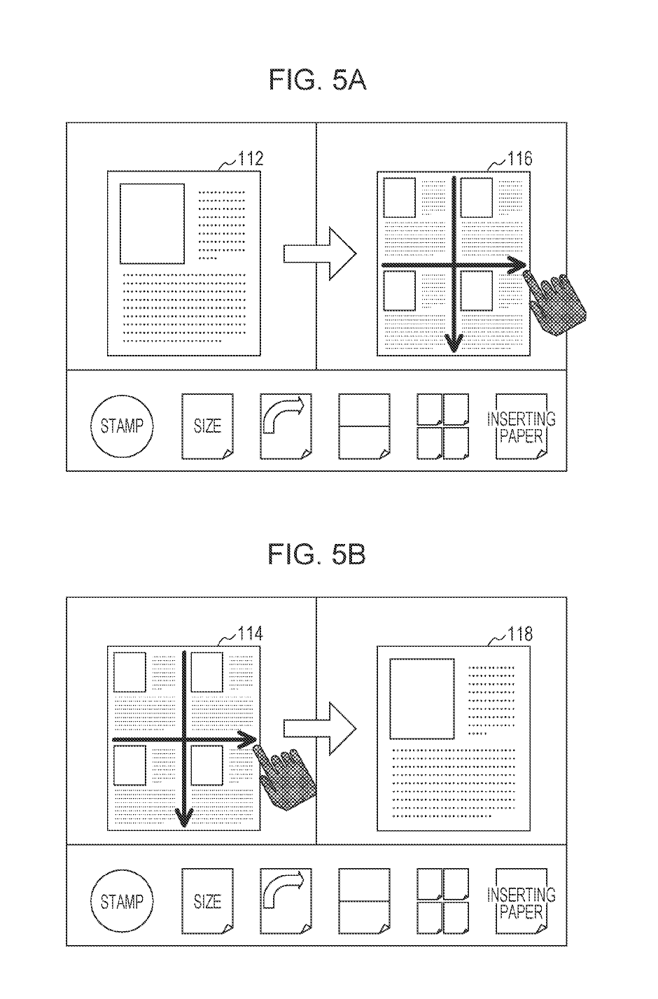

According to the exemplary embodiment, a printing condition is set by making a gesture for the document data displayed in the document data display area 90 or the print data displayed in the print data display area 92. Setting of a printing condition by making a gesture will be described below with reference to FIGS. 5A, 5B, and 8A to 9B. Setting-operation images other than the setting-operation images 100 to 110 described above may be provided as images for setting a printing condition in the setting-operation image display area 94.

In FIG. 4A, an exemplary screen is illustrated in which one page of the document data and one page of the print data are displayed in the document data display area 90 and the print data display area 92, respectively. Alternatively, as in FIG. 4B, a screen may be configured in such a manner that multiple pages of the document data and multiple pages of the print data are displayed in the document data display area 90 and the print data display area 92, respectively.

Now, examples in which the setting unit 76 sets different processing conditions for an identical operation depending on whether the operation reception unit 74 receives the operation as an input-display operation or as an output-display operation will be described with reference to FIGS. 5A to 10B.

FIGS. 5A and 5B are schematic diagrams for explaining a difference in a setting operation using a gesture made by moving a touched position along the shape of a cross, between the state in which the gesture is made as an input-display operation and the state in which the gesture is made as an output-display operation.

As described above, the operation reception unit 74 receives a predetermined gesture as an operation other than a dragging operation using a setting-operation image in the setting-operation image display area 94. In the examples illustrated in FIGS. 5A and 5B, a description will be made for a difference in a setting operation using a gesture made by touching the screen along the shape of a cross as illustrated with arrows in FIGS. 5A and 5B.

In FIG. 5A, a document data image 112 represents one page of document data that is constituted by multiple pages. A document data image 114 represents document data having a configuration in which four pages are laid out into one page, as illustrated in FIG. 5B. In the description below, an image of document data displayed in the document data display area 90 may be called a document data image, and an image of print data displayed in the print data display area 92 may be called a print data image.

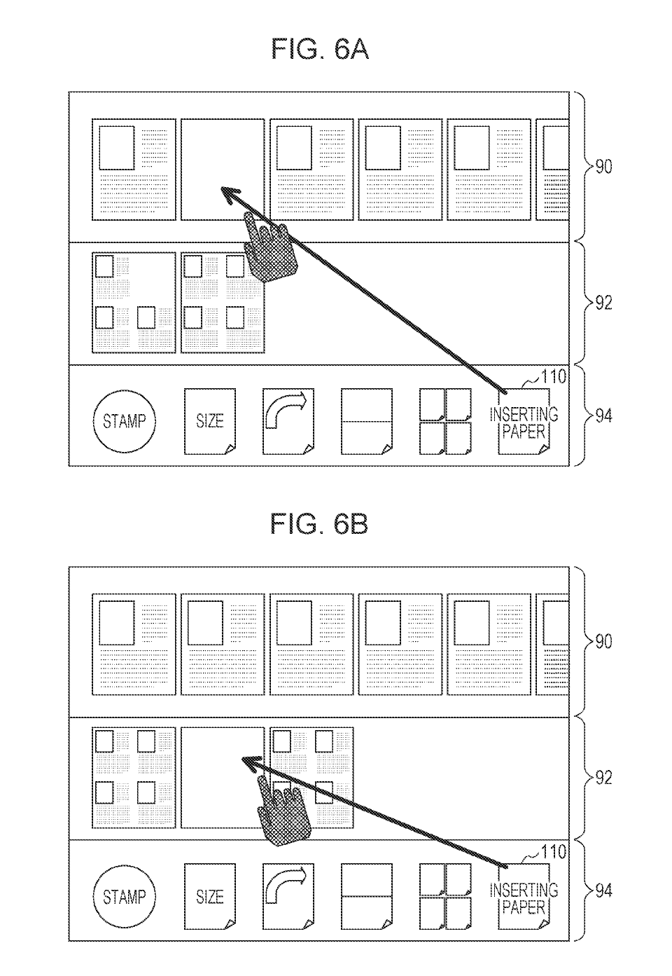

In FIGS. 5A and 5B, print data images 116 and 118 each represent print data which is obtained through application of the setting corresponding to the operation. Before the operation is performed, for example, the same images as the document data images 112 and 114 are displayed as the print data images 116 and 118, respectively. Similarly, in FIGS. 6A to 10B, print data displayed in the print data display area 92 represents a state in which the setting corresponding to an operation has been applied to the print data.

As illustrated in FIG. 5A, when the gesture is made as an output-display operation, the setting unit 76 performs the layout setting operation for laying out four pages into one recording medium. In contrast, as illustrated in FIG. 5B, when the gesture is made as an input-display operation, the setting unit 76 performs the setting operation for dividing one page into four pages to print the resulting pages. One page of multiple pages obtained through the division is displayed as the print data image 118.

Thus, the gesture made by touching the screen along the shape of a cross corresponds to two setting functions. Which setting function is used depends on whether the gesture is made as an input-display operation or as an output-display operation.

FIGS. 6A and 6B are schematic diagrams for explaining a difference in a setting operation using the setting-operation image 110 between the state in which the operation is performed as an input-display operation and the state in which the operation is performed as an output-display operation.

In the examples illustrated in FIGS. 6A and 6B, the layout setting operation has been already performed, and print data in which four pages of the document data are laid out into one page is displayed in the print data display area 92.

As illustrated in FIG. 6A, in the case where the setting-operation image 110 is dragged to the document data display area 90 so that this operation is received as an input-display operation, the setting unit 76 performs the setting operation for laying out the pages on the basis of the document into which inserting paper has been inserted. In contrast, as illustrated in FIG. 6B, in the case where the setting-operation image 110 is dragged to the print data display area 92 so that this operation is received as an output-display operation, the setting unit 76 performs the setting operation for inserting a sheet of inserting paper into the document in which the pages have been laid out.

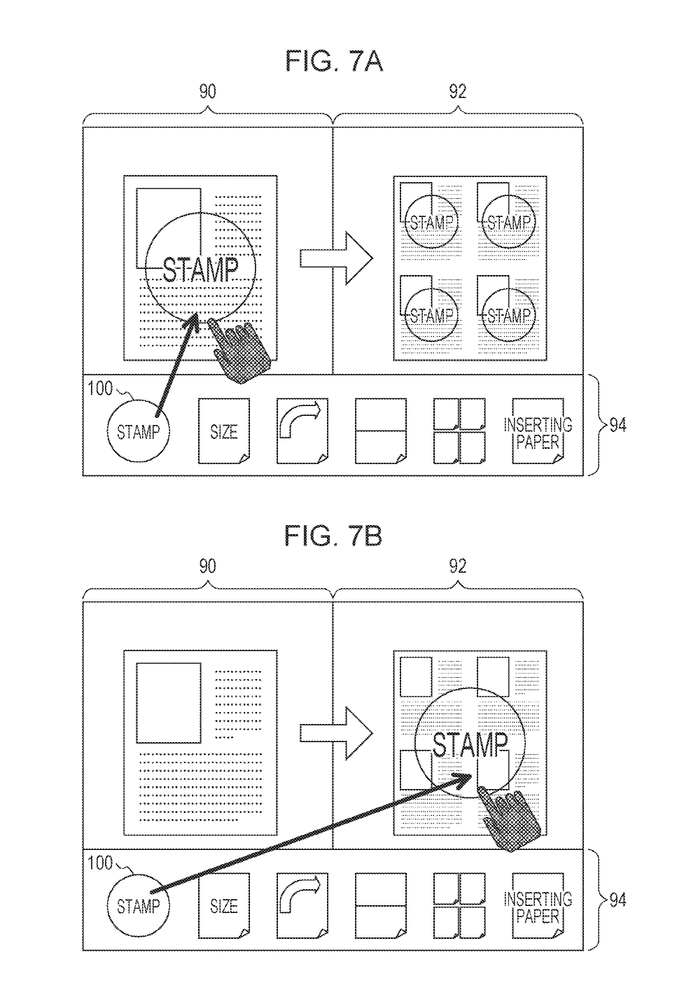

FIGS. 7A and 7B are schematic diagrams for explaining a difference in a setting operation using the setting-operation image 100 between the state in which the operation is performed as an input-display operation and the state in which the operation is performed as an output-display operation.

Similarly, in the examples illustrated in FIGS. 7A and 7B, the layout setting operation has been already performed, and print data in which four pages of the document data are laid out into one page is displayed in the print data display area 92.

As illustrated in FIG. 7A, in the case where the setting-operation image 100 is dragged to the document data display area 90 so that this operation is received as an input-display operation, the setting unit 76 performs the setting operation for laying out the pages on the basis of the document to which an additional image has been added. In contrast, as illustrated in FIG. 7B, in the case where the setting-operation image 100 is dragged to the print data display area 92 so that this operation is received as an output-display operation, the setting unit 76 performs the setting operation for adding an additional image to the document in which the pages have been laid out.

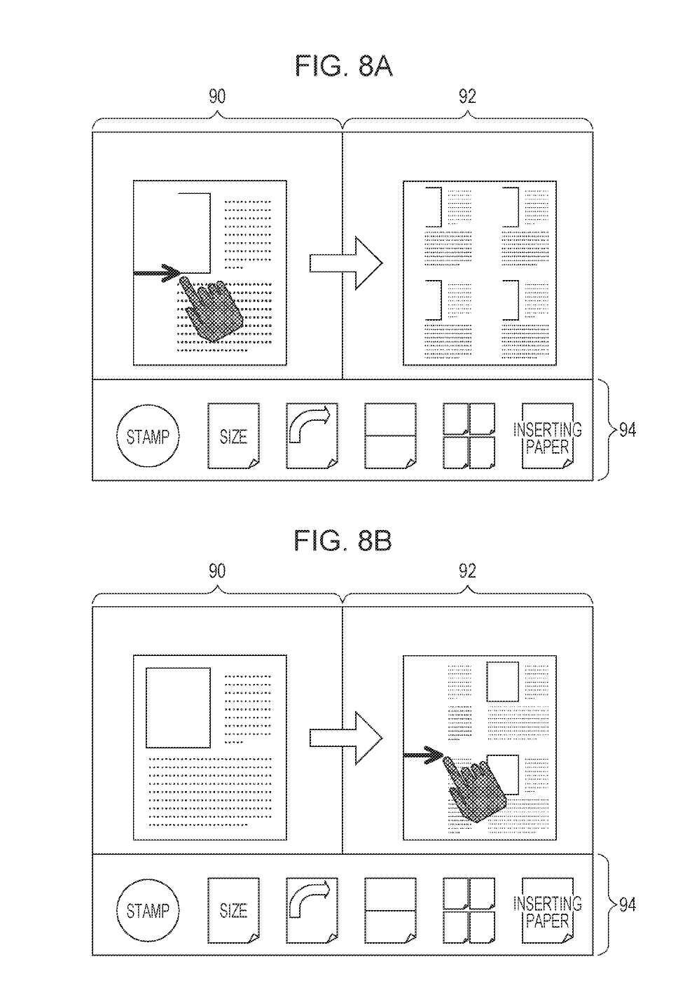

FIGS. 8A and 8B are schematic diagrams for explaining a difference in a setting operation using a gesture for changing a margin width, between the state in which the gesture is made as an input-display operation and the state in which the gesture is made as an output-display operation.

As illustrated with arrows in FIGS. 8A and 8B, the gesture for changing a margin width is made by moving a touched position starting from the inner end of a margin of the document data image or the print data image in the inner direction or the outer direction, so that the setting operation for changing a margin width is performed.

Similarly, in the examples illustrated in FIGS. 8A and 8B, the layout setting operation has been already performed, and print data in which four pages of the document data are laid out into one page is displayed in the print data display area 92.

As illustrated in FIG. 8A, in the case where a gesture for changing a margin width is made in the document data display area 90 so that this gesture is received as an input-display operation, the setting unit 76 performs the setting operation for laying out the pages on the basis of the document in which the margin width has been changed. In contrast, as illustrated in FIG. 8B, in the case where a gesture for changing a margin width is made in the print data display area 92 so that this gesture is received as an output-display operation, the setting unit 76 performs the setting operation for changing a margin width to the document in which the pages have been laid out.

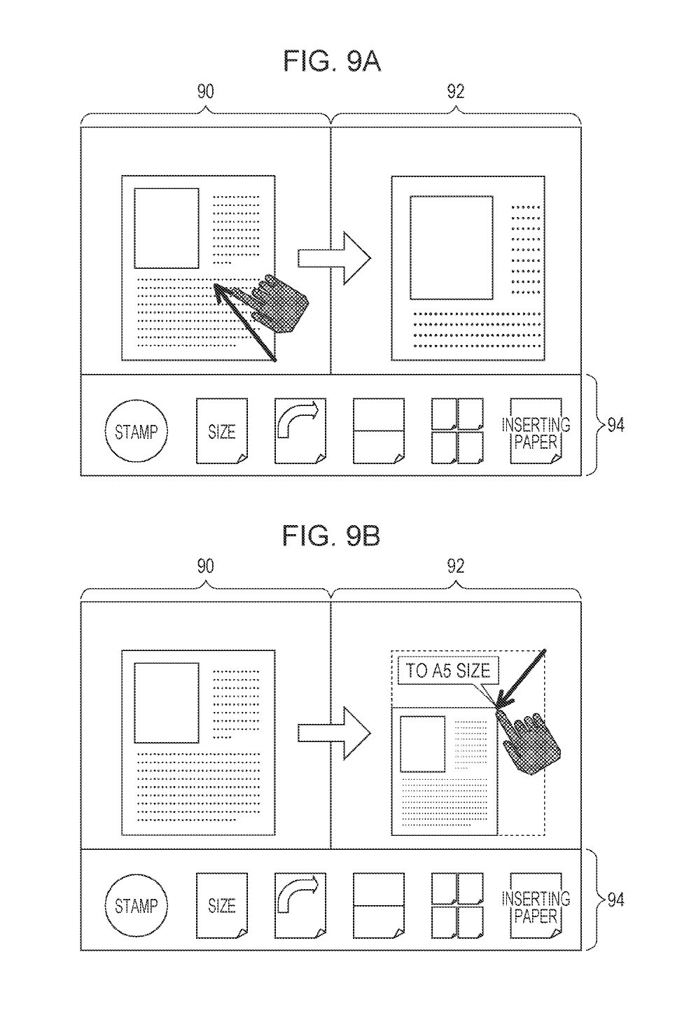

FIGS. 9A and 9B are schematic diagrams for explaining a difference in a setting operation using a gesture made by moving a touched position starting from a corner of a document data image or a print data image, between the state in which the gesture is made as an input-display operation and the state in which the gesture is made as an output-display operation.

As illustrated in FIG. 9A, in the case where the gesture is made as an input-display operation, the setting unit 76 performs the setting operation for enlarging or reducing the document in size, but does not change the size of a recording medium on which an image is to be formed. In contrast, as illustrated in FIG. 9B, in the case where the gesture is made as an output-display operation, the setting unit 76 performs the setting operation for changing the size of a recording medium on which an image is to be formed.

Thus, similarly to the gesture described with reference to FIGS. 5A and 5B, the gesture described with reference to FIGS. 9A and 9B corresponds to two setting functions. Which setting function is used depends on whether the gesture is made as an input-display operation or as an output-display operation.

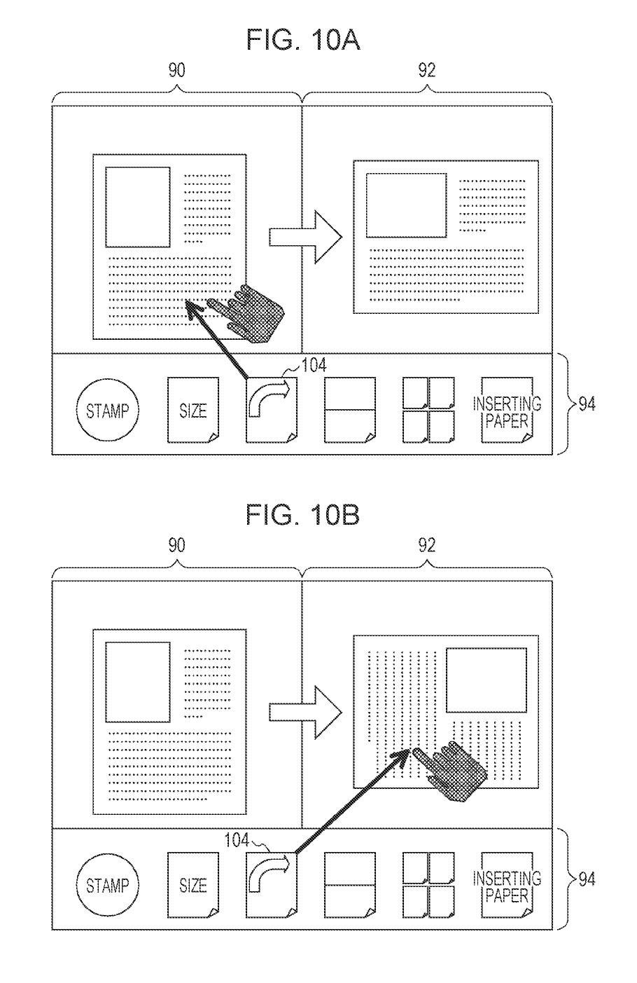

FIGS. 10A and 10B are schematic diagrams for explaining a difference in a setting operation using the setting-operation image 104 between the state in which the operation is performed as an input-display operation and the state in which the operation is performed as an output-display operation.

As illustrated in FIG. 10A, in the case where the setting-operation image 104 is dragged to the document data display area 90 so that this operation is received as an input-display operation, the setting unit 76 performs the document rotation setting operation described above. In contrast, as illustrated in FIG. 10B, in the case where the setting-operation image 104 is dragged to the print data display area 92 so that this operation is received as an output-display operation, the setting unit 76 performs the paper storage orientation setting operation described above.

Now, the relationship between the document rotation setting operation and the layout setting operation will be described.

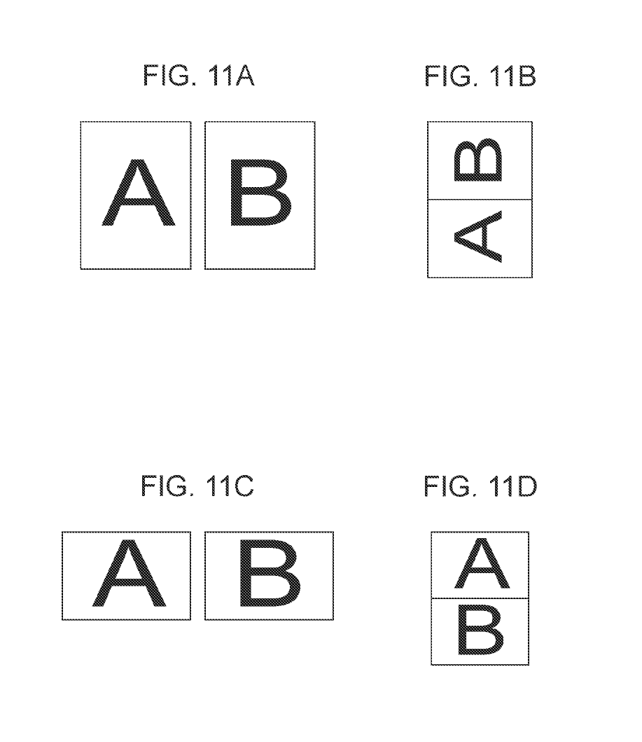

FIGS. 11A to 11D are schematic diagrams illustrating the relationship between the orientation of a document and the layout setting operation. In the case where the layout setting operation is performed on a document disposed in the portrait orientation which is illustrated in FIG. 11A, layout is performed in accordance with the way of layout for a document disposed in the portrait orientation, as illustrated in FIG. 11B. In contrast, in the case where the layout setting operation is performed on a document disposed in the landscape orientation which is illustrated in FIG. 11C, layout is performed in accordance with the way of layout for a document disposed in the landscape orientation, as illustrated in FIG. 11D. For example, an operator performs the document rotation setting operation in order to obtain a desired layout corresponding to the document orientation.

Now, a difference caused by a difference in a sequence in which multiple setting functions are performed will be described.

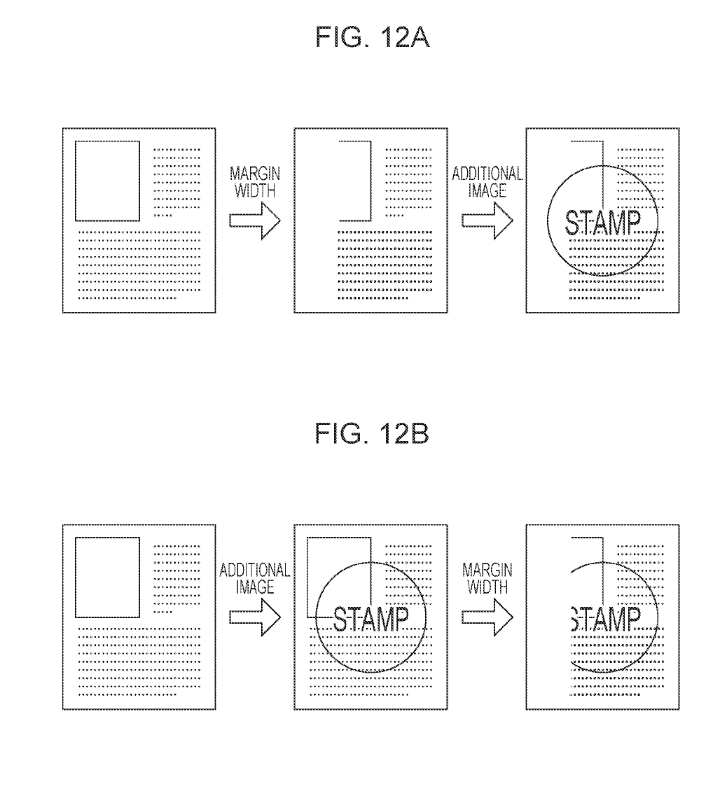

FIGS. 12A and 12B are schematic diagrams for explaining a difference in a printing condition which is caused by a difference in a processing sequence in which the setting operation for changing a margin width and the setting operation for adding an additional image are performed.

FIG. 12A illustrates a sequence of pieces of print data which are obtained by changing a margin width of document data and then adding an additional image to the document data. FIG. 12B illustrates a sequence of pieces of print data which are obtained by adding an additional image to document data and then changing a margin width of the document data. As illustrated in the rightmost pieces of the print data in FIGS. 12A and 12B, the printing conditions are different from each other depending on which process is performed first. Each of the sequences illustrated in FIGS. 12A and 12B remains the same regardless of whether the setting operation for changing a margin width or the setting operation for adding an additional image is an input-display operation or an output-display operation.

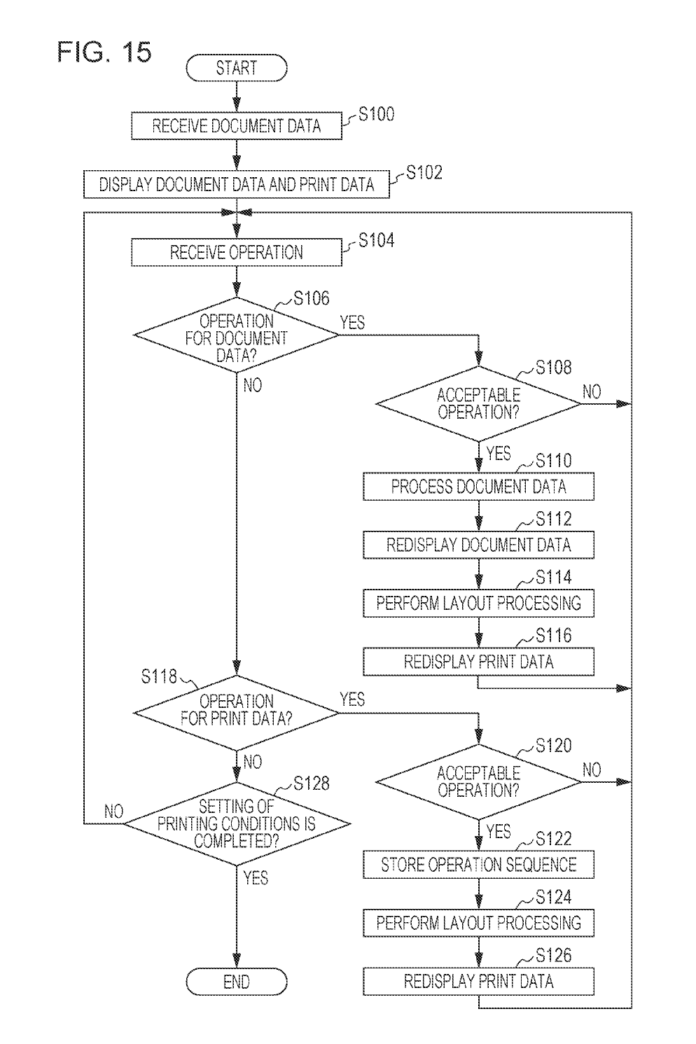

Such a difference between printing conditions which is caused by different sequences of operations is specifically achieved through operations according to the flowchart described below with reference to FIG. 15.

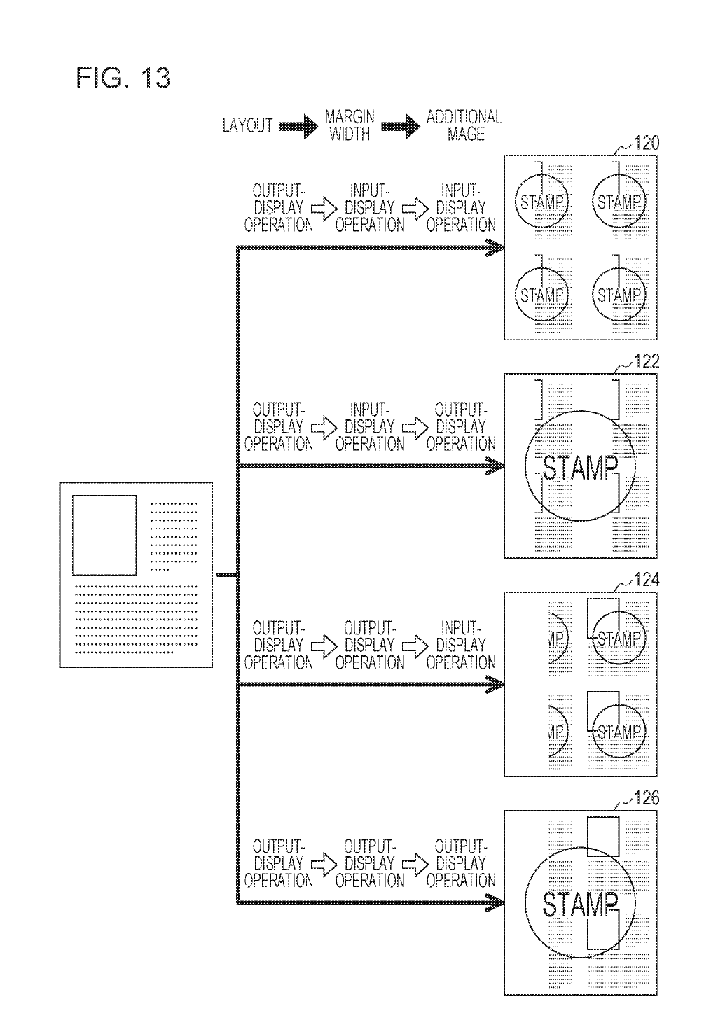

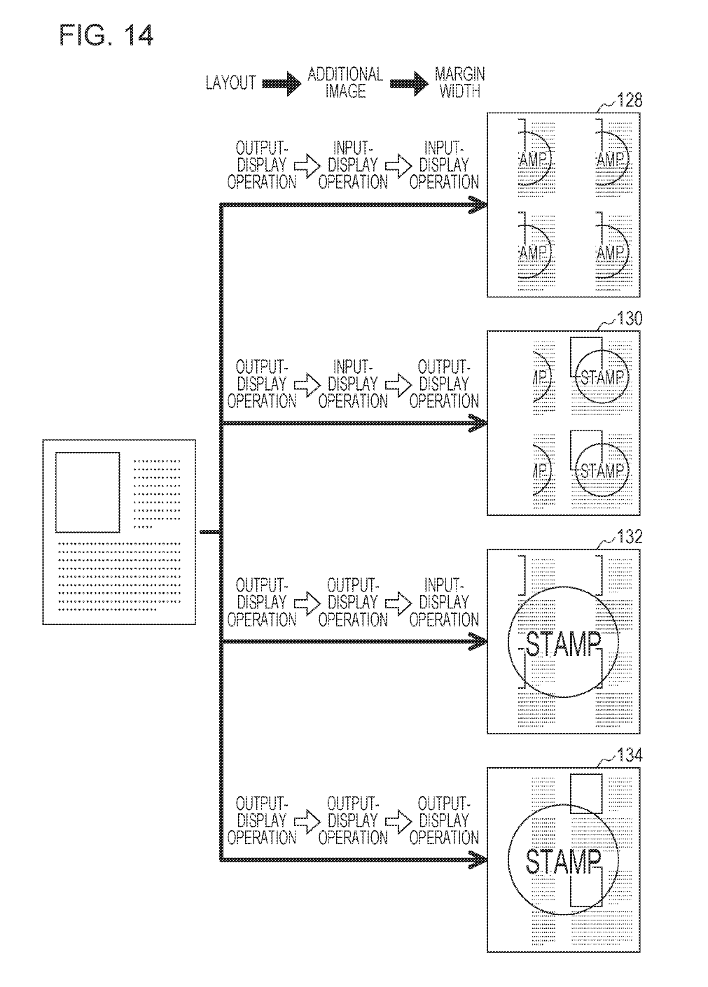

Now, a difference between printing conditions which is caused by different processing sequences in which the setting operation for changing a margin width and the setting operation for adding an additional image are performed to print data which has been subjected to the layout setting operation will be described with reference to FIGS. 13 and 14.

FIG. 13 is a schematic diagram for illustrating a difference in a printing condition in the case where the layout setting operation, the setting operation for changing a margin width, and the setting operation for adding an additional image are performed in this sequence. In FIG. 13, print data 120 indicates print data obtained by performing the layout setting operation, the setting operation for changing a margin width, and the setting operation for adding an additional image, which are received as an output-display operation, an input-display operation, and an input-display operation, respectively, in this sequence. Similarly, pieces of print data 122 to 126 indicate pieces of print data obtained by performing the input-display operations or the output-display operations in the sequences indicated in FIG. 13.

FIG. 14 is a schematic diagram for illustrating a difference in a printing condition in the case where the layout setting operation, the setting operation for adding an additional image, and the setting operation for changing a margin width are performed in this sequence. In FIG. 14, print data 128 indicates print data obtained by performing the layout setting operation, the setting operation for adding an additional image, and the setting operation for changing a margin width, which are received as an output-display operation, an input-display operation, and an input-display operation, respectively, in this sequence. Similarly, pieces of print data 130 to 134 indicate pieces of print data obtained by performing the input-display operations or the output-display operations in the sequences indicated in FIG. 14.

As illustrated in the print data 120 to 134 in FIGS. 13 and 14, the printing conditions are different depending on whether an operation is received as an input-display operation or an output-display operation and on the processing sequences, i.e., operation sequences. Such a difference among the printing conditions is also achieved through operations according to the flowchart described below with reference to FIG. 15.

FIG. 15 is a flowchart of operations performed by the program 70.

In step S100, the input data reception unit 72 receives document data as input data.

In step S102, the input data display unit 78 displays the document data received by the input data reception unit 72 in step S100 in the document data display area 90, and the output data display unit 82 displays the document data received by the input data reception unit 72 in step S100 in the print data display area 92 as print data.

In step S104, the operation reception unit 74 receives an operation performed by an operator on the UI apparatus 50 while determining whether the operation is an input-display operation or an output-display operation.

In step S106, the operation reception unit 74 determines whether or not the received operation is an input-display operation. If the operation is an input-display operation, the process proceeds to step S108. If the process is not an input-display operation, the process proceeds to step S118.

In step S108, the operation reception unit 74 determines whether or not the received operation is an operation for setting a printing condition. If the operation is an operation for setting a printing condition, the process proceeds to step S110. If the operation is not an operation for setting a printing condition, the process returns back to step S104.

In step S110, the document data processor 86 performs a setting function corresponding to the operation received by the operation reception unit 74 on the document data received by the input data reception unit 72 (or, when the document data received by the input data reception unit 72 is already processed by the document data processor 86, the document data obtained through the processing).

In this step, in the case where the operation corresponds to two setting functions as described above, the setting function corresponding to the input-display operation is performed.

In step S112, the input data display unit 78 displays the document data which has been processed by the document data processor 86 in step S110 in the document data display area 90.

In step S114, in the case where the operation sequence storage unit 80 stores output-display operations, the layout processor 88 performs the stored setting functions on the document data which has been processed by the document data processor 86 in step S110, in accordance with the stored operation sequence, and outputs the resulting data to the output data display unit 82 as print data. In the case where the operation sequence storage unit 80 stores no output-display operations, the layout processor 88 outputs the document data obtained from the document data processor 86 to the output data display unit 82 as print data. In this step, in the case where the operation corresponds to two setting functions as described above, the setting function corresponding to the output-display operation is performed.

In step S116, the output data display unit 82 displays the print data which is output from the layout processor 88 in step S114 in the print data display area 92, and the process returns back to step S104.

In step S118, the operation reception unit 74 determines whether or not the operation received in step S104 is an output-display operation. If the operation is an output-display operation, the process proceeds to step S120. If the operation is not an output-display operation, the process proceeds to step S128.

In step S120, the operation reception unit 74 determines whether or not the operation received in step S104 is an operation for setting a printing condition. If the operation is an operation for setting a printing condition, the process proceeds to step S122. If the operation is not an operation for setting a printing condition, the process returns back to step S104.

In step S122, the operation sequence storage unit 80 stores the output-display operation received by the operation reception unit 74 in step S104. In this step, in the case where the operation sequence storage unit 80 already stores output-display operations, the operation sequence storage unit 80 also stores the sequence relationship between the operations that are already stored and the operation that is to be stored. Thus, the operation sequence storage unit 80 stores the output-display operations performed by the operator along with the operation sequence.

In step S124, the layout processor 88 performs the setting function corresponding to the output-display operation received by the operation reception unit 74 in step S104 on the current print data, and outputs the processed print data to the output data display unit 82. In this step, in the case where the operation corresponds to two setting functions as described above, the setting function corresponding to the output-display operation is performed.

In step S126, the output data display unit 82 displays the print data that is output from the layout processor 88 in step S124 in the print data display area 92, and the process returns back to step S104.

In step S128, the setting unit 76 determines whether or not the setting of printing conditions which is to be performed by the operator is completed. Until the setting of printing conditions is completed, operations in steps S104 to S128 are repeated. The completion of the setting of printing conditions is determined on the basis of, for example, reception of an instruction to perform printing.

In accordance with the above-described flowchart, the printing conditions described with reference to FIGS. 4A to 14 are set. The last description will be made as to operations of the above-described flowchart by using a specific example.

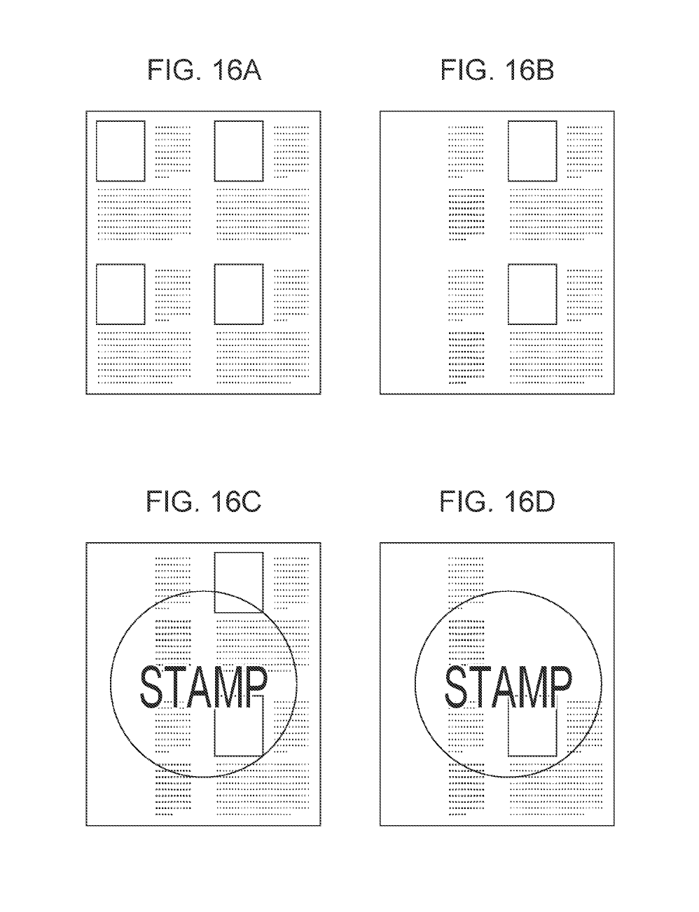

FIGS. 16A to 16D are schematic diagrams for explaining printing conditions in the case where the layout setting operation, the setting operation for changing a margin width, the setting operation for adding an additional image, and the setting operation for inserting a piece of inserting paper are performed.

In the example illustrated in FIGS. 16A to 16D, assume that an operator performs operations in the following procedure. First, the layout setting operation is performed as an output-display operation (hereinafter, referred to as a first operation). Second, the setting operation for changing a margin width is performed as an output-display operation (hereinafter, referred to as a second operation). Third, the setting operation for adding an additional image is performed as an output-display operation (hereinafter, referred to as a third operation). Finally, the setting operation for inserting a piece of inserting paper is performed as an input-display operation (hereinafter, referred to as a fourth operation).

Correspondences between the first to fourth operations described above and the flowchart illustrated in FIG. 15 will be as follows.

Document data is displayed on a screen (in steps S100 and S102), and the first operation is received (in step S104). Since the first operation is determined to be an output-display operation (in steps S106, S118, and S120), the first operation is stored and the layout processor 88 performs a corresponding process (in steps S122 and S124). Then, the print data illustrated in FIG. 16A is displayed in the print data display area 92 (in step S126).

Then, the second operation is received (in step S104). Similarly to the first operation, operations in steps S106, S118, S120, S122, and S124 are performed in this sequence, and the print data illustrated in FIG. 16B is displayed in the print data display area 92 (in step S126).

Then, the third operation is received (in step S104). Similarly to the first and second operations, operations in steps S106, S118, S120, S122, and S124 are performed in this sequence, and the print data illustrated in FIG. 16C is displayed in the print data display area 92 (in step S126).

Finally, the fourth operation is received (in step S104). Since the fourth operation is determined to be an input-display operation (in steps S106 and S108), the document data processor 86 performs a corresponding process on the document data received in step S100 (in step S110), and the resulting document data is displayed (in step S112). The first to third operations stored in the operation sequence storage unit 80 are performed in sequence on the document data which has been processed in step S110 (in step S114). Then, the print data illustrated in FIG. 16D is displayed in the print data display area 92 (in step S116).

Comparing FIG. 16C to FIG. 16D, the only difference caused by the fourth operation is whether or not inserting paper is inserted in the upper right page which has been laid out. Thus, even when the fourth operation, i.e., an input-display operation, is performed, the operation sequence of the first to third operations for the print data is maintained and the layout is also maintained.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An operation receiving apparatus comprising:
an input data display unit that displays input data;
an output data display unit that displays output data generated from the input data on the basis of a processing condition;
an operation reception unit that receives an operation for the input data that is displayed by the input data display unit and an operation for the output data that is displayed by the output data display unit; and
a setting unit that sets the processing condition to be different depending on whether the operation reception unit receives an operation as an operation for the input data that is displayed by the input data display unit or as an operation for the output data that is displayed by the output data display unit.

2. The operation receiving apparatus according to claim 1,
wherein the setting unit sets the processing condition for an identical operation, the processing condition being different depending on whether the operation reception unit receives the identical operation as an operation for the input data that is displayed by the input data display unit or as an operation for the output data that is displayed by the output data display unit.

3. The operation receiving apparatus according to claim 1, further comprising:
an operation sequence storage unit that stores the sequence of a plurality of operations received by the operation reception unit,
wherein the setting unit sets the processing condition in accordance with the sequence stored by using the operation reception unit.

4. The operation receiving apparatus according to claim 2, further comprising:
an operation sequence storage unit that stores the sequence of a plurality of operations received by the operation reception unit,
wherein the setting unit sets the processing condition in accordance with the sequence stored by using the operation reception unit.

5. An image forming apparatus comprising:
a document data display unit that displays document data;
a print data display unit that displays print data generated from the document data on the basis of a printing condition;
an operation reception unit that receives an operation for the document data that is displayed by the document data display unit and an operation for the print data that is displayed by the print data display unit;
a setting unit that sets the printing condition to be different depending on whether the operation reception unit receives an operation as an operation for the document data that is displayed by the document data display unit or as an operation for the print data that is displayed by the print data display unit; and
a print unit that prints the print data generated on the basis of the printing condition that is set by the setting unit.

6. The image forming apparatus according to claim 5, further comprising:
an operation sequence storage unit that stores the sequence of a plurality of operations for the print data displayed by the print data display unit, the plurality of operations being received by the operation reception unit,
wherein, when the operation reception unit receives an operation as an operation for the document data displayed by the document data display unit, the setting unit performs a first process corresponding to the received operation on the document data; and, when the operation reception unit receives an operation as an operation for the print data displayed by the print data display unit, the setting unit performs a second process corresponding to the received operation on the document data which has been subjected to the first process, in accordance with the sequence stored by using the operation reception unit.

7. A non-transitory computer readable medium storing a program causing a computer to execute a process comprising:
displaying input data;
displaying output data generated from the input data on the basis of a processing condition;
receiving an operation for the displayed input data and an operation for the displayed output data; and
setting the processing condition to be different depending on whether an operation is received as an operation for the displayed input data or as an operation for the displayed output data.
